(19) United States
(12) Patent Application Publication
(10) Pub. No.: US 2020/0119614 A1
(43) Pub. Date: Apr. 16, 2020

(54) FLYWHEEL ENERGY STORAGE SYSTEM

(71) Applicant: INDUSTRIAL TECHNOLOGY RESEARCH INSTITUTE, Hsinchu (TW)

(72) Inventors: Huan-Lung Gu, Hualien City (TW); Ming-Tsan Peng, Taoyuan (TW); Chia-Lin Wu, Kaohsiung (TW)

(21) Appl. No.: 16/227,260

(22) Filed: Dec. 20, 2018

(30) Foreign Application Priority Data
Oct. 12, 2018 (TW) 107135990

(51) Int. Cl. H02K 7/02; B60K 6/10

(52) U.S. Cl. CPC H02K 7/025; B60K 6/105; B60W 20/40; B60W 2710/24; B60Y 2400/162

(57) ABSTRACT

The disclosure is related to a flywheel energy storage system comprising a casing, a shaft, a flywheel, and at least one electric motor assembly. The shaft is rotatably disposed in the casing. The flywheel comprises a hub and an annular part, the shaft is disposed through the annular part, the annular part is fixed to the shaft via the hub, and the annular part has at least one cavity. The electric motor assembly is accommodated in the cavity and comprises a first motor rotor and a motor stator. In the cavity, the first motor rotor is fixed on the shaft, and the motor stator is fixed to the casing and located between the first motor rotor and the annular part.

### CROSS-REFERENCE TO RELATED APPLICATIONS

This non-provisional application claims priority under 35 U.S.C. § 119(a) on Patent Application No(s). 107135990 filed in Taiwan, R.O.C. on Oct. 12, 2018, the entire contents of which are hereby incorporated by reference.

### TECHNICAL FIELD

The disclosure relates to a flywheel energy storage system.

### BACKGROUND

Flywheel energy storage (FES) system is a way of energy storage, mainly by accelerating the rotor (having a flywheel) to a very high speed, such that energy can be stored in the system as rotational kinetic energy. When the system needs to output energy, according to the principle of conservation of energy, the rotational speed of the flywheel decreases; when the system needs to store energy, it can increase the rotational speed of the flywheel.

In detail, a typical flywheel energy storage system consists of a chamber containing a flywheel and an electric motor assembly assembled to the flywheel. The flywheel has mechanical potential energy while rotating. The stored energy grows in proportion to the mass and the rotational speed of the flywheel. And when the flywheel's torque with respect to the shaft increases, the stored energy increase in proportional to torque squared. The electric motor assembly acts as an energy output/input device, and it can receive the electric power in the form of a motor to drive the flywheel to rotate, and also can convert the mechanical potential energy of the flywheel into an electric power in the form of a power generator.

Therefore, the flywheel energy storage system can operate as an electric motor or a power generator to directly convert mechanical energy and electrical power. Since the rotational speed of the flywheel can be quickly boosted to absorb or release energy, its power is greater than other energy storage device. For example, the power density of the flywheel energy storage system is significantly higher than that of chemical batteries (e.g., lead-acid battery), making the flywheel energy storage system more suitable than the chemical batteries in some applications that demands fast energy storage, such as wind power plants with large changes in air volume, or wave power plants with large changes in water volume. These applications require quick store/release energy in order to stabilize voltage or electricity. In addition, the flywheel energy storage system is also suitable for vehicles that require instant power input. The above reasons and advantages make the flywheel energy storage system become more important than ever.

However, the conventional flywheel energy storage system still needs to be improved. Specifically, the conventional flywheel energy storage system is too heavy and thus making the vehicle overweight. Therefore, how to decrease the weight and volume of the flywheel energy storage system while maintaining or even increasing both the energy and power density becomes an important topic in the field.

### SUMMARY

One embodiment of the disclosure provides a flywheel energy storage system comprising a casing, a shaft, a flywheel, and two electric motor assemblies. The shaft is rotatably disposed in the casing. The flywheel comprises a hub and an annular part, the shaft is disposed through the annular part, the annular part is fixed to the shaft via the hub, and the annular part has two cavities respectively located at two opposite sides of the hub. The electric motor assemblies are respectively accommodated in the cavities, and each of the electric motor assemblies comprises a first motor rotor and a motor stator. In each of the cavities, the first motor rotor is fixed on the shaft, and the motor stator is fixed to the casing and located between the first motor rotor and the annular part.

Another embodiment of the disclosure provides a flywheel energy storage system comprising a casing, a shaft, a flywheel, and an electric motor assembly. The shaft is rotatably disposed in the casing. The flywheel comprises a hub and an annular part, the shaft is disposed through the annular part, the annular part is fixed to the shaft via the hub, and the annular part has a cavity located at a side of the hub. The electric motor assembly is accommodated in the cavity, and the electric motor assembly comprises a first motor rotor, a second motor rotor, and a motor stator. The first motor rotor is fixed on the shaft, the second motor rotor is fixed on an annular internal wall of the annular part, and the motor stator is fixed to the casing and located between the first motor rotor and the second motor rotor.

### BRIEF DESCRIPTION OF THE DRAWINGS

The present disclosure will become better understood from the detailed description given hereinbelow and the accompanying drawings which are given by way of illustration only and thus are not intending to limit the present disclosure and wherein:

FIG. 1 is a side view of a flywheel energy storage system according to one embodiment of the disclosure;

FIG. 2 is a top view of the flywheel energy storage system in FIG. 1;

FIG. 3 is a top view of a casing of the flywheel energy storage system in FIG. 1;

FIG. 4 is a top view of a flywheel energy storage system according to another embodiment of the disclosure; and

FIG. 5 is a side view of a flywheel energy storage system according to yet another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known main structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained unless the terms have a specific meaning in the present disclosure. Furthermore, in order to simplify the drawings, some conventional structures and components are drawn in a simplified manner to keep the drawings clean.

Further, the terms, such as “end”, “portion”, “part”, “area” and the like may be used in the following to describe specific components and structures or specific features thereon or therebetween, but are not intended to limit these components and structures. In the following, it may use terms, such as “substantially”, “approximately” or “about”; when these terms are used in combination with size, concentration, temperature or other physical or chemical properties or characteristics, they are used to express that, the deviation existing in the upper and/or lower limits of the range of these properties or characteristics or the acceptable tolerances caused by the manufacturing tolerances or analysis process, would still able to achieve the desired effect.

Furthermore, unless otherwise defined, all the terms used in the disclosure, including technical and scientific terms, have their ordinary meanings that can be understood by those skilled in the art. Moreover, the definitions of the above terms are to be interpreted as being consistent with the technical fields related to the disclosure. Unless specifically defined, these terms are not to be construed as too idealistic or formal meanings. The terms of the components in the disclosure are sometimes referred to in a more concise manner, depending on the requirements of the description, and should be understood by the reader.

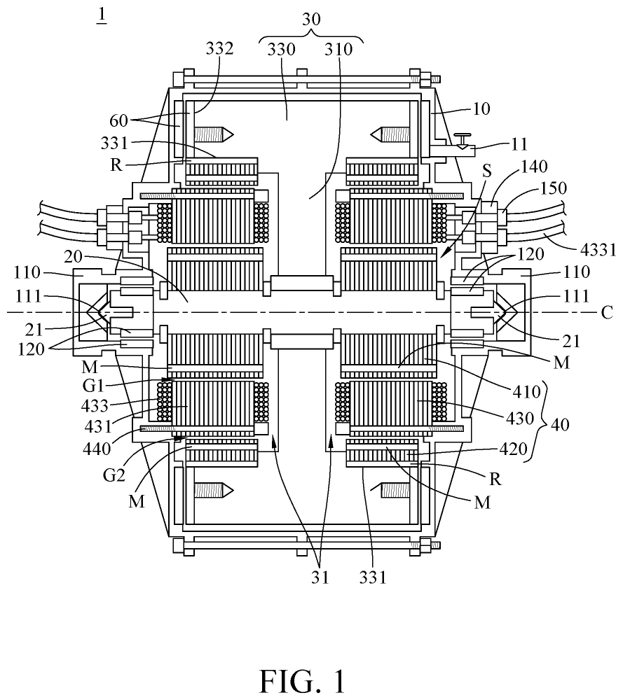

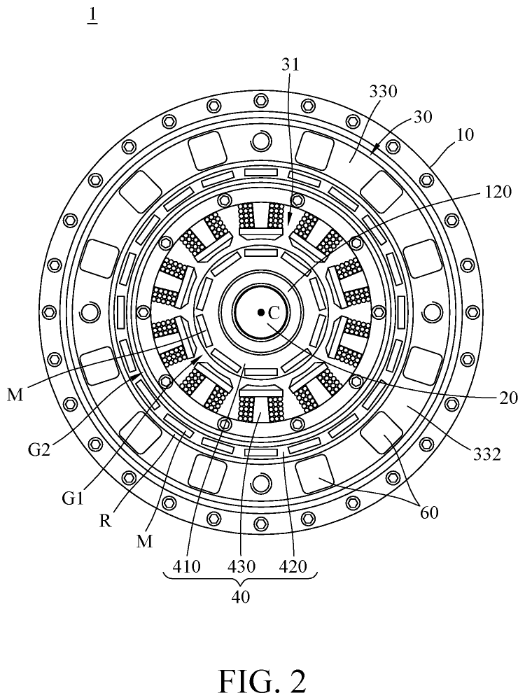

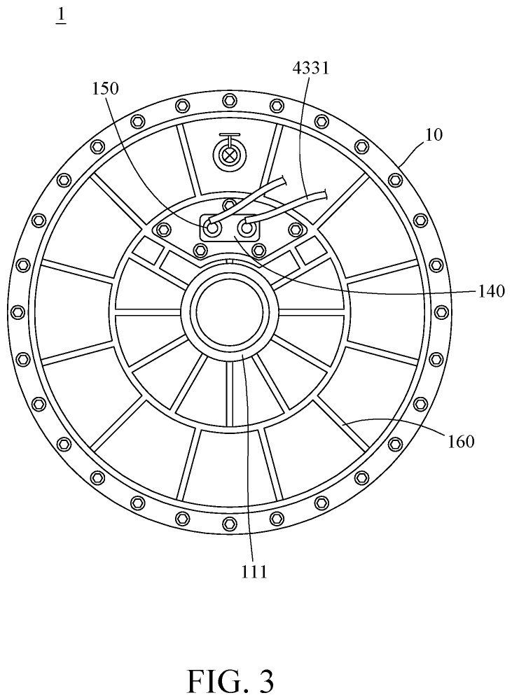

Please refer to FIGS. 1-3, FIG. 1 is a side view of a flywheel energy storage system according to one embodiment of the disclosure, FIG. 2 is a top view of the flywheel energy storage system in FIG. 1, and FIG. 3 is a top view of a casing of the flywheel energy storage system in FIG. 1.

This embodiment provides a flywheel energy storage system 1, may also be simply called “system” hereinafter. The flywheel energy storage system 1 is, for example, a horizontal-type flywheel energy storage system, and may include a casing 10, a shaft 20, a flywheel 30 and two electric motor assemblies 40.

The casing 10 may be made of highly rigid and non-magnetic material, such as aluminum alloy, but the disclosure is not limited thereto. And the casing 10 may have rib structures (e.g., the rib structures 160 shown in FIG. 3) thereon to improve the structural strength. In addition, the casing 10 may be made of a single piece or consisted of plural pieces. In the case that the casing 10 is assembled by a plurality of pieces, these pieces can be fixed to each other via bolts, and the connections between the adjacent pieces can be airtight by applying additional cover or sealant thereto.

In this embodiment, the casing 10 surrounds a chamber S therein for enclosing the shaft 20, the flywheel 30, and the electric motor assemblies 40; that is, the shaft 20, the flywheel 30, and the electric motor assemblies 40 are accommodated in the chamber S. The casing 10 has a vacuum valve 11. The vacuum valve 11 may be connected to a vacuum pump (not shown) used to remove gas from the chamber S to create a vacuum/near vacuum in the chamber S. Therefore, the friction with air occurring during the rotation of the shaft 20, the flywheel 30 and the electric motor assemblies 40 can be greatly reduced, reducing the air resistance in the casing 10 and thus avoiding unwanted energy waste.

In addition, the casing 10 has two bearing seats 110. Each bearing seat 110 is disposed with one or more bearings 120. Two opposite ends of the shaft 20 are respectively rotatably disposed through the bearings 120 and inserted into the bearing seats 110, such that the shaft 20 is rotatable with respect to the casing 10 about a central axis C. The bearing 120 is, for example, a magnetic bearing and is able to largely reduce the friction on the shaft 20, even causing the shaft 20 to have near zero friction with the bearing seat 110.

In more detail, in this embodiment, two opposite ends of the shaft 20 each have a cone-shaped head 21. The cone-shaped heads 21 may be additionally embedded into the shaft 20, but the disclosure is not limited thereto; in other embodiments, the cone-shaped heads and the shaft may be made of a single piece. The tips of the two cone-shaped heads 21 are substantially aligned with the central axis C of the shaft 20. The bearing seats 110 each have a cone-shaped concave 111. The cone-shaped heads 21 respectively fit the cone-shaped concaves 111, and the tips of the cone-shaped concaves 111 are also substantially aligned with the central axis C of the shaft 20. Therefore, when the cone-shaped heads 21 are respectively placed into the cone-shaped concaves 111 of the bearing seats 110, the shaft 20 can be automatically positioned to the desired position. This helps to facilitate the installation of the shaft 20 and also helps to prevent the shaft 20 from unexpectedly shaking. Therefore, the movement of the shaft 20 can be much more stable. As result, the precision of the movement of the rotatable components in the flywheel energy storage system 1 is increased, such that the rotatable components are prevented from unwantedly contacting or hitting the immovable components of the flywheel energy storage system 1. If the precision is insufficient, the rotatable components would start to yaw. As the rotation speed increases, the yaw movement of the shaft will increase, resulting in an increase in vibration. This may cause great damage to the whole system. In severe cases, the components in the system may rupture and fly out, causing accidents such as personal injury.

The flywheel 30 is able to store energy. In order to store more energy per unit volume or weight (i.e., to increase the energy density), in this embodiment or other embodiments, the shape of the flywheel 30 is substantially cylindrical. As shown in the figure, the flywheel 30 includes a hub 310 and an annular part 330. The shaft 20 is disposed through the annular part 330, and the annular part 330 is connected and fixed to the shaft 20 through the hub 310, such that the flywheel 30 and the shaft 20 can be rotated together. In this embodiment, the flywheel 30 and the shaft 20 are concentric and their centers coincide on the central axis C of the shaft 20. Note that the disclosure is not limited by how the hub 310 is fixed to the shaft 20.

Due to the geometric configuration of the annular part 330, most of the mass of the flywheel 30 is located away from the shaft 20 (i.e., located away from the central axis C) and thus helping to increase the rotational torque so as to increase the density of the rotational potential energy. In detail, due to the geometric configuration of the annular part 330, most of the mass of the flywheel 30 is located at where the rotational torque is relatively high, such that the weight of the flywheel 30 is largely decreased but the rotational inertia is increased, thereby increasing the ratio of inertia to weight. The reason is that the potential energy of the flywheel 30 is generated by the rotational inertia, the potential energy is proportional to the inertia and rotational speed, and the inertia is proportional to the mass and in proportion to torque squared. Thus, the portion of the flywheel 30 away from the central axis C (i.e., the annular part 330) is the area that can produce a larger torque and thus producing larger potential energy. As such, removing the middle part of the flywheel 30 would not decrease too much the inertia but would be able to largely decrease the overall weight of the flywheel 30, that is, to significantly improve the energy density of the flywheel 30.

Additionally, the material of the flywheel 30 may have high structural strength, high density and non-magnetic or electrical insulation, helping to increase the mass per unit volume and to prevent it from breaking caused by huge centrifugal force, but the disclosure is not limited thereto.

In this embodiment, the annular part 330 of the flywheel 30 has two cavities 31 respectively located at two opposite sides of the hub 310. The electric motor assemblies 40 are respectively located in the cavities 31 to make best use of the inner space of the flywheel 30 and to largely decrease the overall volume of the flywheel energy storage system 1, thereby increasing the energy density of the system. Accordingly, the geometric configuration of the flywheel 30 not only helps to decrease the overall weight and to accommodate the electric motor assemblies 40 but also helps to increase the energy density. The electric motor assemblies 40 are respectively located at two opposite sides of the hub 310 of the flywheel 30 and arranged along the central axis C of the shaft 20. These two electric motor assemblies 40 are required to be well controlled to operate synchronously with each other in order to maintain the mechanical stability of the system.

Specifically, each electric motor assembly 40 includes a first motor rotor 410, a second motor rotor 420 and a motor stator 430. In each cavity 31, the first motor rotor 410 is fixed on the shaft 20, the second motor rotor 420 is fixed on an annular internal wall 331 of the annular part 330, and the motor stator 430 is fixed on the casing 10 and located between the first motor rotor 410 and the second motor rotor 420. In such a configuration, the motor stator 430 and the casing 10 are considered as immovable components, and the first motor rotor 410, second motor rotor 420, flywheel 30 and shaft 20 are considered as rotatable components (may also be called movable components), and these four rotatable components can be rotated synchronously.

In addition, there may be one or more non-magnetic materials R located between the second motor rotor 420 and the annular internal wall 331 of the annular part 330. If the material of the flywheel 30 has magnetic permeability, the non-magnetic materials R can block the magnetic line of force so as to prevent the variation of the magnetic line of force from producing eddy current on the annular internal wall 331 to unwantedly consume energy, but the disclosure is not limited by the non-magnetic material R and its material. Further, the disclosure is not limited by how the motor stator 430 is fixed to the casing 10; in this or other embodiments, the motor stator 430 may be fixed to the casing 10 via, for example, bolts 440.

In more detail, in each electric motor assembly 40, the first motor rotor 420 and the motor stator 430 are spaced apart by a first gap G1, and the second motor rotor 420 and the motor stator 430 are spaced apart by a second gap G2. In the two electric motor assemblies 40, the first gaps G1 are respectively located at the two opposite sides of the hub 310 of the flywheel 30, and the second gaps G2 surround the first gaps G1 and are also respectively located at the two opposite sides of the hub 310 of the flywheel 30. These gaps (i.e., the gaps G1-G2) allow the first motor rotor 410 and the second motor rotor 420 to cooperate with the motor stator 430 without mechanical interference.

In this configuration, the first motor rotors 410 of the electric motor assemblies 40 are respectively located at two opposite sides of the hub 310 of the flywheel 30 and arranged along the central axis C of the shaft 20, and the first motor rotors 410 are able to be rotated about the central axis C; the second motor rotors 420 are also respectively located at two opposite sides of the hub 310 of the flywheel 30 and arranged along the central axis C of the shaft 20, and the second motor rotors 420 are also able to be rotated about the central axis C; and the motor stators 430 are also respectively located at two opposite sides of the hub 310 of the flywheel 30 and arranged along the central axis C of the shaft 20.

In another perspective, the motor stators 430 of the electric motor assemblies 40 surround the shaft 20 and the first motor rotor 410, and the second motor rotors 420 surround the motor stators 430. In other words, the motor stators 430 are located at a side of the first motor rotors 410 away from the shaft 20, and the second motor rotors 420 are located at a side of the motor stators 430 away from the shaft 20; alternatively, the first motor rotors 410 are located at a side of the motor stators 430 close to the central axis C, and the second motor rotors 420 are located at a side of the motor stators 430 away from the central axis C.

The first motor rotors 410, that are fixed on the shaft 20, and the second motor rotors 420, that are fixed on the annular internal wall 331 of the annular part 330, are able to be rotated synchronously with the shaft 20 so as to be rotated with respect to the motor stators 430, that are fixed on the casing 10, and thus producing torque.

From the side view, the flywheel 30 is configured as taking the central axis C of the shaft 20 as the central line of symmetry, and the electric motor assemblies 40 are arranged as taking the hub 310 of the flywheel 30 as the central line of symmetry, such that the whole system is substantially a symmetrical duo-electric-motors configuration. This helps to obtain better dynamic balance and mechanical dynamic stress distribution when the above rotatable components rotate at high speed and is beneficial to the durability of the bearings 20 and to improve the stability of the overall system.

In this embodiment, the motor stator 430 includes at least one magnet 431 and windings 433 wound on the magnet 431. Note that the type and the arrangement of the windings 433 are not restricted. In addition, as shown in FIGS. 1 and 3, the windings 433 are connected to a connecting cable 4331 penetrating through the casing 10 for transmitting electric power. The hole of the casing 10 for the connecting cable 4331 can be added with airtight materials to maintain the airtightness of the casing 10. In one example, the airtight materials may be a non-conductive mount (e.g., bakelite 140) that is fixed on the casing 10 with pads or gaskets therebetween, there may be one or more conductive components (e.g., the bolts 150) mounted on the mount 140, and the connecting cable 4331 is secured on two opposite ends of the bolt 150 to take the bolt 150 as a pathway of electric power. This configuration achieves the power supply and airtight and makes the installation of the connecting cable 4331 easy.

The external electric power can be transmitted to the windings 433 of the motor stators 430 via the connecting cable 4331 and thus causing the windings 433 to produce electromagnetic field, and the magnetic line of force of the electromagnetic field passes through the first and second gaps G1 and G2 and the magnetic material of the motor stators 430 to interact with the first motor rotor 410 and the second motor rotor 420.

The first motor rotor 410 and the second motor rotor 420 each are made of laminated silicon steel sheets, which can avoid the formation of eddy current on the surface of the magnetic material while the magnetic field passing through; in addition, the first motor rotor 410 and the second motor rotor 420 are disposed with at least one permanent magnet M, such that both the first motor rotor 410 and the second motor rotor 420 can produce a permanent magnetic field for creating magnetic force with the motor stator 430. Note that the quantity of the permanent magnets M can be adjusted according to actual requirements. Accordingly, the permanent magnetic fields of the first motor rotor 410 and the second motor rotor 420 would form independent magnetic loops (magnetic flux paths) on different portions of the motor stator 430 to respectively interact with the windings 433 of the motor stator 430, increasing the magnetic flux per unit area. Also, since the magnetic line of force exerts on different portions of the motor stator 430 so that the main magnetic fields (i.e., the relatively strong area) of the magnetic loops do not overlap with each other. Therefore, although the overall magnetic flux is greatly increased, the magnetic saturation of the magnetic material of the motor stator 430 is still less possible to occur.

Due to the large increase of the magnetic flux, when the flywheel energy storage system 1 performs motor function, applying the same amount of current to the flywheel energy storage system 1 can create a greater force to rotate the flywheel 30, meaning that the input power is enhanced; when the flywheel energy storage system 1 performs power generator function, the flywheel 30 rotates the first motor rotor 410 and the second motor rotor 420, and a greater electromotive force is created as the magnetic line of force passes through the windings 433 of the motor stator 430, meaning that the output power is enhanced.

As such, when the external electric power is applied to the flywheel energy storage system 1, the flywheel energy storage system 1 can operate as an electric motor, and the changing electromagnetic fields are produced while the electric power passing through the windings 433 of the motor stators 430 to force the first motor rotors 410 and the second motor rotors 420 to rotate, thereby forcing the shaft 20 and the flywheel 30, that are fixed to the first motor rotors 410 and the second motor rotors 420, to rotate together. As the flywheel 30 rotates, it starts to store energy. As long as the electric motor assembly 40 continuously generates magnetic force to drive the flywheel 30 to rotate, the rotational speed of the flywheel 30 can be continuously increased, allowing the flywheel energy storage system 1 to store energy until the magnetic line of force of the magnetic material is saturated. On the other hand, when an external device requires electrical power from the system, there will be no external electric power imported into the system, then the magnetic line of force results from the permanent magnetic fields of the first and second motor rotors 410 and 420 passes through the windings 433 of the motor stator 430, and the permanent magnetic fields are continuously moved by the rotating flywheel 30 so as to continuously interact with the windings 433 and thus causing the windings 433 to produce electromotive force, i.e., electric potential energy. The electric potential energy can be provided to the external device via the connecting cable 4331. At this moment, the flywheel energy storage system 1 acts as an electric power source that is able to provide electric energy to external device.

Accordingly, there are first and second motor rotors 410 and 420 interact with different portions of the motor stator 430 at the same time, the magnetic line of force results from the first and second motor rotors 410 and 420 would pass through the windings 433 whether the system is outputting electric energy or receiving electrical power, when the magnetic force and the electric power interact with each other, the inner and outer portions of the motor stator 430 both have a magnetic field of the permanent magnet M, and the magnetic line of force is largely increased but not overlapping, thereby greatly increasing the power density and also preventing the existence of magnetic saturation of the magnetic materials.

In addition, in this embodiment, the flywheel energy storage system 1 further includes a plurality of bearings 60 that are respectively disposed on two opposite end surfaces 332 of the annular part 330 of the flywheel 30 facing the casing 10. The bearings 60 are also magnetic bearings, and the bearings 60 are larger than the bearings 120 so that they can provide a larger magnetic force to reduce mechanical friction between the rotatable components (e.g., the first motor rotor 410, second motor rotor 420, flywheel 30 and shaft 20), for further stabilizing the operation of the system. Note that the magnetic bearings 60 and 120 can be precisely aligned due to the cooperation of the cone-shaped heads 21 and the cone-shaped concaves 111.

In other embodiments, the flywheel energy storage system may not include the second motor rotor 420. In such a case, the first motor rotor 410 is fixed on the shaft, and the motor stator 430 is fixed on the casing 10 and located between the first motor rotor 410 and the annular part 330.

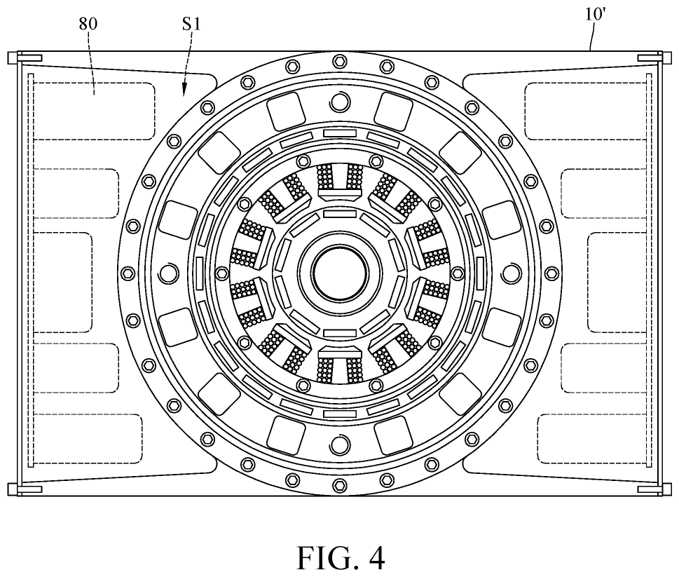

Moreover, in other embodiments, the flywheel energy storage system can be combined with a control room. As shown in FIG. 4, FIG. 4 is a top view of a flywheel energy storage system according to another embodiment of the disclosure. One of the main differences between this and previous embodiments is the structure of the casing; thus the other components not described hereinafter may be substantially the same as that in the previous embodiment. In this embodiment, the casing 10′ may further have a control room space S1 which is achieved by expanding the casing 10′. The control room space S1 is configured to accommodate one or more controllers 80 used to control the system and the electric motor assembly. In this embodiment, the control center and the flywheel energy storage system are integrated together, avoiding the need for additional external space for the controller and avoiding the long connection between the system and the controller. Therefore, the overall volume of the flywheel energy storage system can be decreased; that is, the energy and power density per unit volume can be increased.

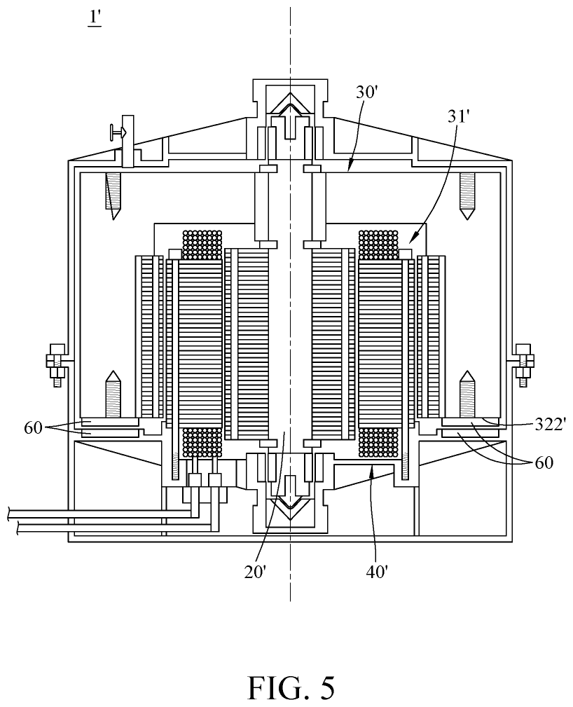

Then, please refer to FIG. 5, which is a side view of a flywheel energy storage system according to yet another embodiment of the disclosure. One of the main differences between this and previous embodiments is the quantity of the electric motor assembly, and other components can be properly modified according to such difference. As shown in the figure, this embodiment provides a flywheel energy storage system 1′ that has a flywheel 30′ having only one cavity 31′; in such a case, the flywheel energy storage system 1′ includes only one electric motor assembly 40′ located in the cavity 31′. Note that the detail descriptions about the components of the flywheel energy storage system 1′, such as the electric motor assembly 40′, flywheel 30′ and shaft 20, can be referred to the previous embodiment.

In this embodiment, the cavity 31′ is located at one side of the flywheel 30′, but the disclosure is not limited by the orientation of the cavity 31′. As the exemplary embodiment shown in FIG. 5, the cavity 31′ is oriented downward.

Also, in such orientation, the shaft 20′ can be rotated in a vertical manner, such that the flywheel energy storage system 1′ becomes a vertical-type flywheel energy storage system, allowing most of the system's components to be supported by the ground. Therefore, the system is allowed to use a larger mass of flywheel 30′. In addition, all of the rotatable components are arranged as taking the shaft 20′ as the central line of symmetry; and only the end surface 332′ of the flywheel 30 facing downward is required to be mounted with the bearings 60, which helps to reduce the cost. Further, the vertical-type flywheel energy storage system is more adapted to an application that would not change the orientation.

Here, it is additionally noted that the magnetic force density of the permanent magnet is extremely high, which not only improves the efficiency of the electric motor, but also improves the applicability of the flywheel energy storage system, but the permanent magnet has a very strong magnetic field. In order to avoid the motor stator and the flywheel from magnetically attracting to each other while assembling them, the screw hole and the long bolt can be used as the main assembly tools. The end surface of the flywheel may have screw hole, and the casing may have holes for the bolt. While gradually inserting the long bolt into the screw hole, the components that respectively attached with the motor stator and the motor rotor can be moved in the determined path and spaced apart by a determined distance. Therefore, the simple tools such as the long bolt and handy tool can be used to assemble and position the components of the flywheel energy storage system. The assembly process is simple and also one of the features of the disclosure.

As discussed above, the flywheel energy storage system provided in the disclosure at least provides the following advantages:

1. Due to the geometric configuration of the annular part of the flywheel, most of the mass of the flywheel is located away from the shaft (i.e., located away from the central axis C) and thus helping to increase the rotational torque so as to increase the density of the rotational potential energy;

2. Accommodating the electric motor assembly in the cavity of the flywheel is able to increase the magnetic flux so as to greatly increase the power density and also able to increase the rotational inertia of the flywheel; that is, the geometric configuration of the flywheel helps to increases the overall energy and power density. It means that the flywheel energy storage system of the disclosure can reach the predetermined rotational speed to store energy in a shorter period of time and can provide electric power to the external device also in a shorter period of time;

3. The electric motor assembly includes the first and second motor rotors and the motor stator located between the motor rotors, such that the magnetic line of force can pass through the outer and inner portions of the motor stator at the same time, which allows the motor rotor to use thinner magnets to generate the required amount of magnetic flux, thereby reducing the cost. And the first motor rotor and second motor rotor can form independent magnetic loops on different portions of the motor stator, and the magnetic loops do not overlap with each other; therefore, although the overall magnetic flux is greatly increased, the magnetic saturation of the magnetic material of the motor stator is still less possible to occur;

4. The end surfaces of the flywheel and two opposite ends of the shaft are all disposed with magnetic bearings to greatly reduce the mechanical friction of the rotatable components, such as the first and second motor rotors, the shaft and the flywheel, thereby stabilizing the operation of the system;

5. The chamber in the casing can be vacuum/near vacuum, such that the rotatable components, such as the first and second motor rotors, shaft and flywheel can be rotated in a vacuum environment. Therefore, the friction with air occurring during the rotation of the shaft, the flywheel, and the electric motor assemblies can be significantly reduced, reducing the air resistance in the casing and thus decreasing the unwanted energy waste; as such, the rotational potential energy of the flywheel can last longer;

6. The control center and the flywheel energy storage system are integrated together, avoiding the need for additional external space for the controller and avoiding the long connection between the system and the controller;

7. In the vertical-type flywheel energy storage system, the flywheel is arranged in a vertical manner, allowing most of the system's components to be supported by the ground. Therefore, the system is allowed to use a larger mass of flywheel. And only the end surface of the flywheel facing downward is required to be mounted with the magnetic bearings, which helps to reduce the cost; and

8. In the horizontal-type flywheel energy storage system, the electric motor assemblies are respectively located at two opposite cavities of the flywheel; thus, the electric motor assemblies are arranged as taking the hub of the flywheel as the central line of symmetry. This helps to obtain better dynamic balance and mechanical dynamic stress distribution.

According to the flywheel energy storage system as discussed above, it has a higher energy and power density per unit weight or volume and is fast in energy conversion, such that the flywheel energy storage system is suitable for lighter, smaller, and high power output/input applications. For example, the flywheel energy storage system is suitable for some certain types of vehicles that demand in fast electrical power input/output and fast conversion of electrical and mechanical energy.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A flywheel energy storage system, comprising:
a casing;
a shaft, rotatably disposed in the casing;
a flywheel, comprising a hub and an annular part, the shaft disposed through the annular part, the annular part fixed to the shaft via the hub, and the annular part having two cavities respectively located at two opposite sides of the hub; and
two electric motor assemblies, respectively accommodated in the cavities, and each of the electric motor assemblies comprising a first motor rotor and a motor stator;
wherein in each of the cavities, the first motor rotor is fixed on the shaft, and the motor stator is fixed to the casing and located between the first motor rotor and the annular part.

2. The flywheel energy storage system according to claim 1, wherein each of the electric motor assemblies further comprises a second motor rotor, the second motor rotor is fixed on an annular internal wall of the annular part, and the motor stator is fixed to the casing and located between the first motor rotor and the second motor rotor.

3. The flywheel energy storage system according to claim 2, wherein the first motor rotors of the electric motor assemblies are respectively located at two opposite sides of the hub of the flywheel and are arranged along a central axis of the shaft.

4. The flywheel energy storage system according to claim 2, wherein the second motor rotors of the electric motor assemblies are respectively located at two opposite sides of the hub of the flywheel and are arranged along a central axis of the shaft.

5. The flywheel energy storage system according to claim 2, wherein the motor stators of the electric motor assemblies are respectively located at two opposite sides of the hub of the flywheel and are arranged along a central axis of the shaft.

6. The flywheel energy storage system according to claim 2, wherein the motor stators of the electric motor assemblies surround the shaft and the first motor rotors, and the second motor rotors surround the motor stators.

7. The flywheel energy storage system according to claim 2, wherein in each of the electric motor assemblies, the motor stator is located at a side of the first motor rotor away from the shaft, and the second motor rotor is located at a side of the motor stator away from the shaft.

8. The flywheel energy storage system according to claim 2, wherein the first motor rotor and the motor stator are spaced apart by a first gap, and the first gaps of the electric motor assemblies are respectively located at two opposite sides of the hub.

9. The flywheel energy storage system according to claim 8, wherein the second motor rotor and the motor stator are spaced apart by a second gap, the second gap surrounds the first gap, the second gaps of the electric motor assemblies are respectively located at the two opposite sides of the hub.

10. The flywheel energy storage system according to claim 2, wherein the shaft has two cone-shaped heads respectively located at two opposite ends of the shaft, the casing has two cone-shaped concaves that respectively fit the cone-shaped heads, and the cone-shaped heads are respectively located in the cone-shaped concaves.

11. A flywheel energy storage system, comprising:
a casing;
a shaft, rotatably disposed in the casing;
a flywheel, comprising a hub and an annular part, the shaft disposed through the annular part, the annular part fixed to the shaft via the hub, and the annular part having a cavity located at a side of the hub; and
an electric motor assembly, accommodated in the cavity, the electric motor assembly comprising a first motor rotor, a second motor rotor, and a motor stator, wherein the first motor rotor is fixed on the shaft, the second motor rotor is fixed on an annular internal wall of the annular part, and the motor stator is fixed to the casing and located between the first motor rotor and the second motor rotor.
